(19) United States
(12) Patent Application Publication
(10) Pub. No.: US 2019/0114712 A1
(43) Pub. Date: Apr. 18, 2019

(54) SYSTEM AND METHOD FOR SUPPORTING DECISION ACCORDING TO MULTIPLE AGGREGATED DECISIONS

(71) Applicant: ZEPA FINANCIAL TECHNOLOGY LTD., Ra'anana (IL)

(72) Inventors: EYAL LUSTMAN, RA'ANANA (IL); GIL GOLAN, HERZLIYA (IL)

(21) Appl. No.: 16/161,303

(22) Filed: Oct. 16, 2018

Related U.S. Application Data
(60) Provisional application No. 62/572,619, filed on Oct. 16, 2017.

(51) Int. Cl. G06Q 40/06; G06Q 30/02; G06Q 30/06

(52) U.S. Cl. CPC G06Q 40/06; G06Q 30/0631; G06Q 30/0206

(57) ABSTRACT

A social financial decision making system for enabling users to make financial decisions in an informed manner, the system including at least one profile generator operable to generate a profile matrix, at least one data gathering unit, and at least one presentation mechanism for presenting financial data to the users, where the presentation mechanism is configured and operable to present financial data pertaining to multiple products, the financial data including a first quality index pertaining to cost associated with each product transaction, a second quality index pertaining to potential profit of each product, and a third quality index pertaining to a peer comparison for each product.

### FIELD AND BACKGROUND

The disclosure herein relates to systems and methods for supporting decisions according to multiple aggregated decisions. In particular the system may use the wisdom of crowds to support Social Financial Decision Making method of users and/or financial institutions, according to similar decisions taken by the user's peers and further according to the user's profile.

### SUMMARY

It is according to aspects of the current disclosure to present a social financial decision making system for enabling users to make financial decisions in an informed manner. The system may comprise: at least one profile generator operable to generate a profile matrix; at least one data gathering unit; and at least one presentation mechanism for presenting financial data to said users, The presentation mechanism may be configured and operable to present financial data pertaining to a plurality of products.

The products may include various financial offerings such as, amongst others, pension related products, insurance products, investment products, saving products, loan products, mortgages and the like, as well as combinations thereof.

The financial data may comprise: a first quality index pertaining to cost associated with each product transaction; a second quality index pertaining to potential profit of each product; and a third quality index pertaining to a peer comparison for each product.

Optionally, the profile matrix comprises at least one of a financial profile component and a behavioral profile component.

Typically, the financial profile component comprises data pertaining to at least one financial-characterization parameter. Where appropriate, at least one financial-characterization parameter is selected from the group consisting of: personal information, family status, income data, current and forecasted financial assets, socioeconomic factors, social status, information regarding financial products and insurance cover and combinations thereof.

Typically, the behavioral profile component comprises data pertaining to at least one user behavioral-characterization parameter indicative of decision making habits of said user. Where appropriate, at least one user behavioral-characterization parameter is selected from at least one of a group consisting of: personal information, family status, income data, current and forecasted financial assets, socioeconomic factors, social status, information regarding financial products, insurance cover and combinations thereof.

Optionally, the social financial decision making system further comprises at least one vendor assistance mechanism for generating targeted products for particular purchaser profile. Where appropriate, the vendor assistance mechanism is operable to provide segmental pricing for unlimited financial profiles.

Additionally or alternatively, the social financial decision making system further comprises at least one product costing mechanism for generating suggested costs for each product.

Optionally, the social financial decision making system further comprises at least one purchaser assistance mechanism for providing a personalized product for a purchaser profile.

Another aspect of the current disclosure is to teach a social financial decision making method for enabling users to make financial decisions in an informed manner. The social financial decision making method comprises: providing at least one profile generator operable to generate a profile matrix; providing at least one data gathering unit; and providing at least one presentation mechanism for presenting financial data to said users; and visually presenting financial data pertaining to a plurality of products, said financial data comprising: a first quality index pertaining to cost associated with each product transaction, a second quality index pertaining to potential profit of each product; and a third quality index pertaining to a peer comparison for each product.

Optionally the social financial decision making method further comprises generating said profile matrix by selecting at least one of a financial profile component and a behavioral profile component.

Typically, the social financial decision making method further comprises generating a financial profile component comprising data pertaining to at least one financial-characterization parameter. Where appropriate, at least one financial-characterization parameter is selected from the group consisting of: personal information, family status, income data, current and forecasted financial assets, socioeconomic factors, social status, information regarding financial products and insurance cover and combinations thereof.

Additionally or alternatively, the social financial decision making method further comprises generating a behavioral profile component comprises data pertaining to at least one user behavioral-characterization parameter indicative of decision making habits of said user. Where appropriate the behavioral-characterization parameter is selected from at least one of a group consisting of: personal information, family status, income data, current and forecasted financial assets, socioeconomic factors, social status, information regarding financial products, insurance cover and combinations thereof.

Optionally the social financial decision making method further comprises generating suggested costs for each product. Additionally or alternatively, the social financial decision making method further comprises generating targeted products for particular purchaser profile.

Typically, the social financial decision making method further comprises generating segmental pricing for unlimited financial profiles.

Optionally the social financial decision making method further comprises least one purchaser assistance mechanism for providing a personalized product for a purchaser profile.

### BRIEF DESCRIPTION OF THE DRAWINGS

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the various selected embodiments may be put into practice. In the accompanying drawings:

FIGS. 1A-C are a set of screenshot showing a summary page indicating a user's projected income upon retirement based upon their pension and savings;

FIG. 2 is a screenshot showing a comparison of a user's current savings product with alternative savings products available. The screenshot includes a characteristic flag indicating a preferred product based upon the product profile and a user profile of the user as well as aggregated decisions made by the user's peers, and

FIG. 3 is another screenshot indicating the combined wealth of a household including two wage earners each having separate savings products.

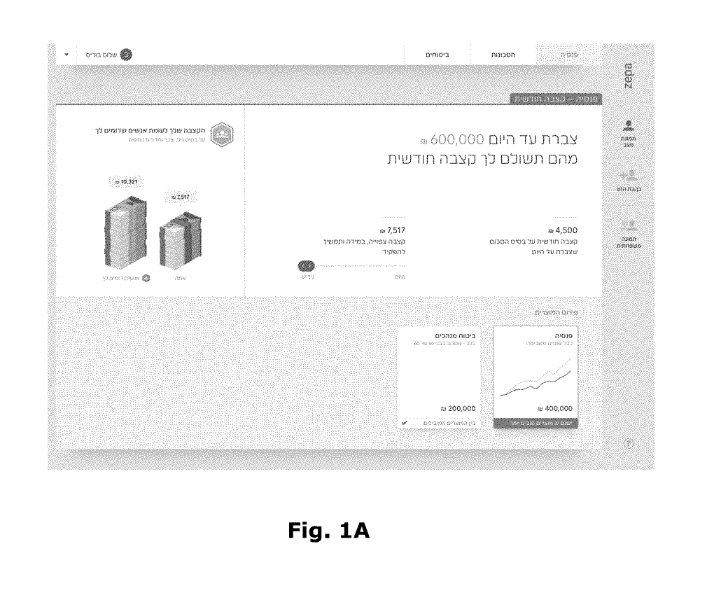

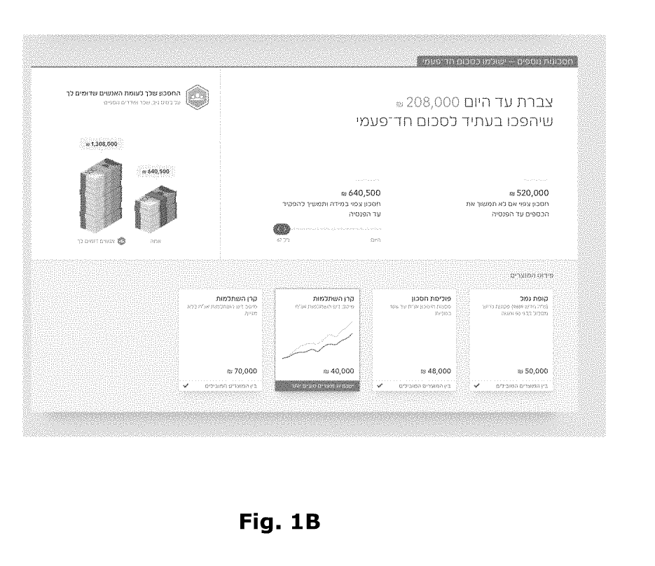

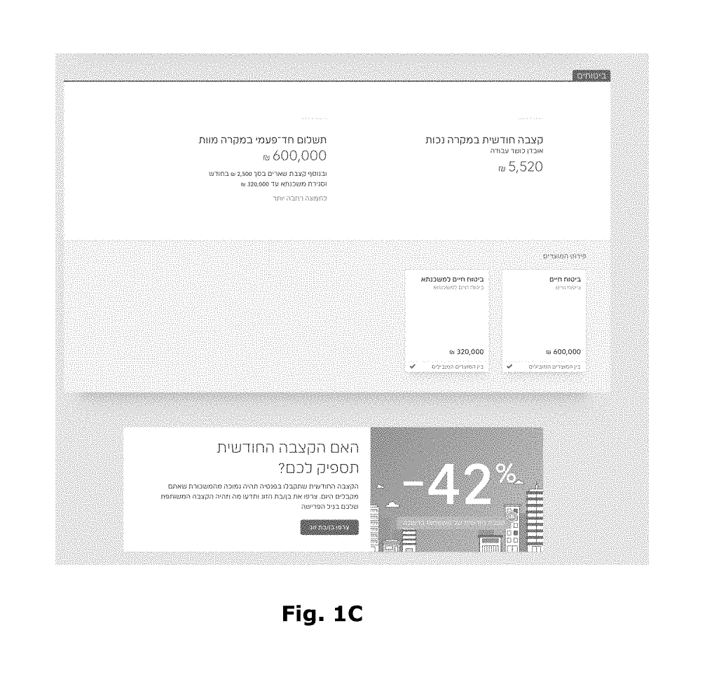

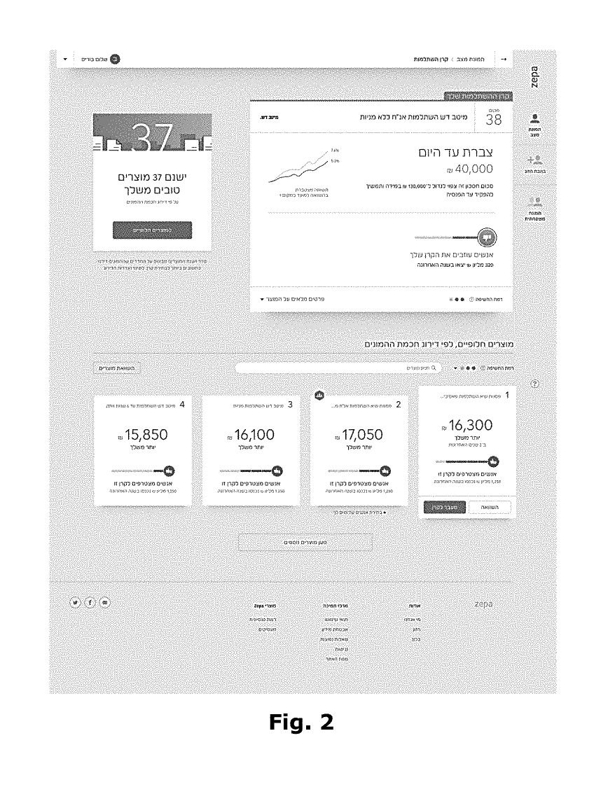

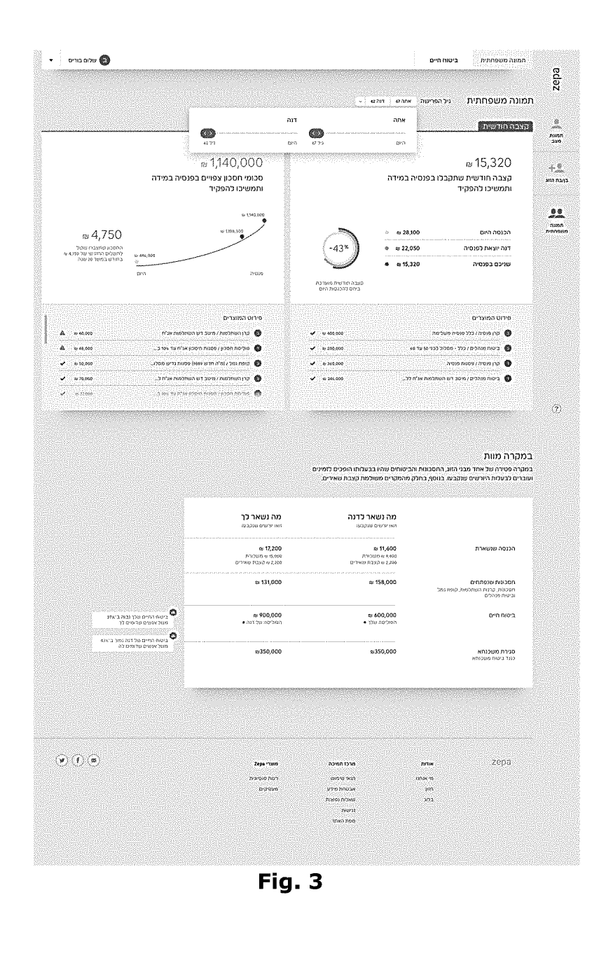

### DETAILED DESCRIPTION

Aspects of the present disclosure relate to systems and methods for supporting decisions according to multiple aggregated decisions.

In various embodiments of the disclosure, one or more tasks as described herein may be performed by a data processor, such as a computing platform or distributed computing system for executing a plurality of instructions. Optionally, the data processor includes or accesses a volatile memory for storing instructions, data or the like. Additionally or alternatively, the data processor may access a non-volatile storage, for example, a magnetic hard-disk, flash-drive, removable media or the like, for storing instructions and/or data.

It is particularly noted that the systems and methods of the disclosure herein may not be limited in its application to the details of construction and the arrangement of the components or methods set forth in the description or illustrated in the drawings and examples. The systems and methods of the disclosure may be capable of other embodiments, or of being practiced and carried out in various ways and technologies.

Alternative methods and materials similar or equivalent to those described herein may be used in the practice or testing of embodiments of the disclosure. Nevertheless, particular methods and materials are described herein for illustrative purposes only. The materials, methods, and examples are not intended to be necessarily limiting.

A method is disclosed for smart decision making using the wisdom of crowds via a social financial decision making system. In particular, the system may be used to assist in the formation of personal financial decisions.

In order to form financial decisions it may be important to combine the analysis of financial parameters with an analysis of similar decisions and a comparison with actions taken by peers. Such a combination may enable an informed decision to be made.

The system may involve a number of methods including:
A user profiling algorithm
A market and product profiling for analyzing various products available
A commercialization algorithm for assisting commercial decision making particularly for financial institutions and the like.

Such methods and their like may be combined to form various dashboards or working environments, these include:

In a first setting the user profile and the market profiling methods may be combined to present data for assisting with a product purchaser to form an informed decision.

In a second setting the commercialization algorithm may be used to assist the vendor to make informed decisions.

Accordingly, a combination of informed vendor decisions with informed purchaser decisions may enable informed commercial transactions.

In some embodiments, the user profiling algorithm may apply a social financial decision making method (SFDM) to the user. Optionally, the SFDM method may be based upon a user profile matrix having at least two main components: A Financial Profile component and a Behavioral Profile component.

The Financial Profile component of the user profile matrix may include data pertaining to personal information, family status, income data, current and forecasted financial assets, socioeconomic factors, social status, information regarding financial products and insurance cover.

The products may include various financial offerings such as, amongst others, pension related products, insurance products, investment products, saving products, loan products, mortgages and the like, as well as combinations thereof.

The Behavioral Profile component includes information mapping characteristic selections and decisions of a user. Such characteristics may include their reluctance to take risks (risk aversion parameter), financial preferences, alternative selection, response to wisdom of crowd suggestions, user sensitivity to profit and loss, usage of the system.

Accordingly, the system may generate a broad range of financial profiles and behavioral profiles.

Application of the user SFDM system may be enabled by the system learning how the users make decisions, recognizing patterns in decision making method for various different profile types.

The system may also add other important or necessary layers to the user activity for particular profile types. This layer of product analysis may generate financial decisions.

In some embodiments, the market and product profile may apply SFDM methods to analyze the quality of various products available on the market. The analysis relies upon an original SFDM concept, according to which the quality of a product is influenced by crowd sourced decisions relating to the product taken by multiple users.
In the first stage the system may analyze the effectiveness of each candidate product according to scale of a variety of financial parameters.
Applying the SFDM method in this analysis is expressed by the way in which the system analyzes the personal priorities of each user regarding those parameters, how the user uses these parameters to form decisions, and the relative importance and weight given to each parameter.
Accordingly, the system enables each user to receive social financial data including the decisions made by all that users peer-group users. The data may include:
   A product ranking according to the peer users, and
   Product selections made by peer users, and
   Products' parameters selection using the system settings by peer users

In some embodiments, the financial institutions may apply SFDM to form commercial decisions for financial bodies. The decisions may be made according to SFDM which has surprisingly been found to enable automated financial transactions. A vendor may contact a purchaser or a type of a purchaser as part of a group and/or personally but anonymously by using the purchaser's user profile. Additionally or alternatively, the vendor may use user profiles to approach a purchaser in a non-specific manner. The purchaser's decision may be made in the system and only afterwards may the two sides be made aware of each other's identities.

It is noted that because the system may have information regarding how the users make decisions, it may learn in parallel how financial bodies make commercial decisions. Accordingly, the system may generate the decisions which the financial bodies need to make in order to effect a commercial transaction with a user.

What is claimed is:

1. A social financial decision making system for enabling users to make financial decisions in an informed manner, the system comprising:
at least one profile generator operable to generate a profile matrix;
at least one data gathering unit; and
at least one presentation mechanism for presenting financial data to said users;
wherein said presentation mechanism is configured and operable to present financial data pertaining to a plurality of products, said financial data comprising:
a first quality index pertaining to cost associated with each product transaction;
a second quality index pertaining to potential profit of each product; and
a third quality index pertaining to a peer comparison for each product.

2. The social financial decision making system of claim 1 wherein said profile matrix comprises at least one of a financial profile component and a behavioral profile component.

3. The social financial decision making system of claim 2 wherein said financial profile component comprises data pertaining to at least one financial-characterization parameter.

4. The social financial decision making system of claim 3 wherein said at least one financial-characterization parameter is selected from the group consisting of: personal information, family status, income data, current and forecasted financial assets, socioeconomic factors, social status, information regarding financial products and insurance cover and combinations thereof.

5. The social financial decision making system of claim 2 wherein said behavioral profile component comprises data pertaining to at least one user behavioral-characterization parameter indicative of decision making habits of said user.

6. The social financial decision making system of claim 5 wherein said at least one user behavioral-characterization parameter is selected from at least one of a group consisting of: personal information, family status, income data, current and forecasted financial assets, socioeconomic factors, social status, information regarding financial products, insurance cover and combinations thereof.

7. The social financial decision making system of claim 1 further comprising at least one product costing mechanism for generating suggested costs for each product.

8. The social financial decision making system of claim 1 further comprising at least one vendor assistance mechanism for generating targeted products for particular purchaser profile.

9. The social financial decision making system of claim 8 wherein said vendor assistance mechanism is operable to provide segmental pricing for unlimited financial profiles.

10. The social financial decision making system of claim 1 further comprising at least one purchaser assistance mechanism for providing a personalized product for a purchaser profile.

11. A social financial decision making method for enabling users to make financial decisions in an informed manner, the method comprising:
providing at least one profile generator operable to generate a profile matrix;
providing at least one data gathering unit;
providing at least one presentation mechanism for presenting financial data to said users; and
visually presenting financial data pertaining to a plurality of products, said financial data comprising: a first quality index pertaining to cost associated with each product transaction, a second quality index pertaining to potential profit of each product; and a third quality index pertaining to a peer comparison for each product.

12. The social financial decision making method of claim 11 further comprising: generating said profile matrix by selecting at least one of a financial profile component and a behavioral profile component.

13. The social financial decision making method of claim 11 further comprising: generating a financial profile component comprising data pertaining to at least one financial-characterization parameter.

14. The social financial decision making system of claim 11 wherein said at least one financial-characterization parameter is selected from the group consisting of: personal information, family status, income data, current and forecasted financial assets, socioeconomic factors, social status, information regarding financial products and insurance cover and combinations thereof.

15. The social financial decision making method of claim 11 further comprising: generating a behavioral profile component comprises data pertaining to at least one user behavioral-characterization parameter indicative of decision making habits of said user.

16. The social financial decision making method of claim 15 wherein said at least one user behavioral-characterization parameter is selected from at least one of a group consisting of: personal information, family status, income data, current and forecasted financial assets, socioeconomic factors, social status, information regarding financial products, insurance cover and combinations thereof.

17. The social financial decision making method of claim 11 further comprising generating suggested costs for each product.

18. The social financial decision making method of claim 11 further comprising generating targeted products for particular purchaser profile.

19. The social financial decision making method of claim 11 further comprising generating segmental pricing for unlimited financial profiles.

20. The social financial decision making method of claim 11 further comprising at least one purchaser assistance mechanism for providing a personalized product for a purchaser profile.
